(19) United States
(12) Patent Application Publication
(10) Pub. No.: US 2025/0178464 A1
(43) Pub. Date: Jun. 5, 2025

(54) CONNECTOR FOR A SUPPLY CABLE

(71) Applicant: Robert Bosch GmbH, Stuttgart (DE)

(72) Inventors: Georg Wallensteiner, Gemmrigheim (DE); Hannes Kahlhammer, Remseck a. Neckar (DE); Martin Schmidt, Stuttgart (DE)

(21) Appl. No.: 18/841,414

(22) PCT Filed: Feb. 27, 2023
(86) PCT No.: PCT/EP2023/054832

§ 371 Date: Oct. 1, 2024

(30) Foreign Application Priority Data
Feb. 28, 2022 (DE) 10 2022 202 007.3

(51) Int. Cl. B60L 53/16; B60L 53/18; H01R 13/502; H01R 13/52; H01R 13/66

(52) U.S. Cl. CPC B60L 53/16; B60L 53/18; H01R 13/502; H01R 13/5202; H01R 13/6658; H01R 2201/26

(57) ABSTRACT

A connector for a supply cable for electrically connecting a vehicle to a power supply device, which provides electric power, and/or to a load, which requires electric power. The connector includes: a housing with a housing interior; a printed circuit board which has an electrical and/or electronic circuit; and a holding element for the printed circuit board; The housing has an inner wall, which delimits the housing interior, wherein the inner wall has a first portion and a second portion opposite the first portion. The holding element has an elastically reversible material or is predominantly or completely made of an elastically reversible material. The printed circuit board is mounted in the housing interior in a clamped manner, by the holding element.

### FIELD

The present invention relates to a connector for a supply cable for electrically connecting a vehicle to a power supply device, which provides electric power, and/or to a load, which requires electric power. The present invention furthermore relates to a supply cable having such a connector.

### BACKGROUND INFORMATION

Various approaches are described in the related art for electrically charging electric vehicles or hybrid vehicles (e.g., cars, trucks, boats, aircraft, two-wheelers, etc.). The vehicle can be charged in a first charging situation via a dedicated charging infrastructure, wherein the charging stations are in particular fixedly installed charging stations. For example, such charging stations are realized as a charging column or wall box. In an alternative charging situation, a continuous current socket is provided, as is used, for example, in normal households for power supply. For example, this is a (e.g., 230 V) Schuko [protective contact] socket or a socket designed in accordance with other regional standards or customs, wherein a three-phase current connection can also be provided. In this case, a connecting line of the charging cable generally has an integrated controller, which is also referred to as an in-cable control box, ICCB, and which is arranged between the two connectors within the connecting line. This integrated controller serves to communicate with the vehicle and to release and set a charging current since, in contrast to a charging column or a wall box, a Schuko socket generally does not have a communication line via which the vehicle can communicate with the power supply device.

Such charging or energy transfer can be made possible by a supply line or supply cable, which is often commonly referred to as a charging cable. Such a supply cable or supply line usually has a connector (often referred to as a charging plug) at each of its two ends, one of which is electrically connected to the vehicle (primary connector) and the other to the power supply device or a load (secondary connector) (the load may also be another vehicle). A connecting line, through which the electrical current flows, is arranged between the two connectors.

Such connectors often have a housing. Inside the housing, a connection unit is often arranged on a connection side or at a connection end (which can be connected, for example, to the vehicle or the power supply device or the load). This can, for example, serve as a mechanical interface to the corresponding connection partner. Accordingly, it has a defined geometry toward the outer side or external environment (e.g., a type 2 plug face or a three-phase plug face, etc.). Furthermore, a line element is often arranged inside the housing on a line side or line end that faces the connecting line. This can, for example, be part of the connecting line or a line section that belongs to the connector and can be connected to the connecting line on the outer side of the housing or outside of the housing of the connector, e.g., by means of a coupling.

It can be provided that a printed circuit board is arranged in a housing interior of the housing. Such a connector is described in German Patent Application No. DE 10 2015 104 107 A1.

### SUMMARY

The present invention is based on the finding that a connector for a supply cable can be exposed to mechanical influences (e.g., jolts, vibrations, pressure, thermally induced mechanical stresses and/or shocks). For example, a connector may fall from an operator's hand and fall, for example, from a height of, for example, 1 m to 1.5 m onto a hard floor (e.g., concrete floor). It may also be exposed to vibrations and/or jolts, for example during transport in a vehicle, or it may be loaded with weight in a vehicle's cargo area, for example with luggage, which puts pressure on it. The connector may also be exposed to high weight and/or pressure, for example due to a rollover (e.g., by a car). It is also based on the finding that the connector can have a printed circuit board, which makes various functionalities of the connector possible, e.g., the release of high electrical voltages (>100 V), voltage conversion (e.g., from more than 100 V to voltages in the range between 5 V and 30 V) in order to use the converted voltage, for example, to switch a bypass switch (a type of relay), etc. In this case, for a safe and reliable function of the connector over the planned service life (often several years and/or several thousand plug-in operations, which in reality correspond to use over several years), the function of the printed circuit board and/or the electrical and/or electronic circuitry arranged on it should not be impaired, even under such adverse conditions. In order to prevent this, the electronic components are often connected as so-called THT components (THT=through-hole technology) to the printed circuit board. In this case, the components have wire legs, which are inserted through through-connections in the printed circuit board and subsequently soldered to the printed circuit board. In contrast to, for example, an SMD assembly (SMD=surface-mounted device), this equipping method is however time-consuming and expensive and makes it more difficult to equip the printed circuit board with components on both sides. In this case, the THT assembly is often not limited to heavy (e.g., having a mass of at least 5 g, e.g., having a mass of between 5 g and 70 g, preferably having a mass of between 10 g and 50 g) electrical or electronic components, such as relays or voltage converters. Equipping the printed circuit board with THT components in this way takes up additional space on the rear side of the printed circuit board because of the legs that protrude through the printed circuit board. Another possibility to minimize the risk in the case of mechanical influences on the housing (e.g., jolts, shocks, etc.) is to encapsulate the printed circuit board after it has been equipped, e.g., with a gel and/or a resin or the like. However, such a potting process is an additional process step and therefore time-consuming; the potting compound is costly and not necessarily environmentally friendly. Furthermore, potting is an unclean process step that can result in splashes in non-wanted regions. In addition, such potting increases the weight of the printed circuit board and thus also of the connector. This unnecessarily increases the force (or torque) exerted on a mating connector (e.g., household socket, vehicle charging socket, wall box charging socket, etc.).

Furthermore, it has been shown that, for a safe and reliable use of such connectors, in particular for the protection of a printed circuit board in the housing interior, it is necessary that no or the smallest possible amount of dirt, grime, moisture or fluid media in general penetrate into an interior of the housing. For example, it may be required that the connector meets a protection class, such as IP55, IP65, IP57, IP67 or even better.

This can be achieved, for example, by manufacturing the housing in one piece by overmolding the connection unit and the line section with plastics material, as is described in the related art, for example in the infrastructure-side connectors of chargers for mobile phones.

Although it has been shown that complete overmolding or potting or “foaming” of larger connectors, such as those used for supply lines for electric vehicles, is basically possible and a very high level of tightness can be achieved, this makes such a connector very heavy since a large volume must be filled with the injection molding material and/or foaming material (e.g., a thermoplastic and/or thermosetting plastic). The costs are also comparatively high due to the high consumption of plastics material. In addition, such a connector is almost impossible to repair if a defect occurs inside it. As a result, in such a case, the defective connector often renders the entire supply cable unusable, which contradicts the desire for sustainable products.

However, if the housing is made of multiple parts for manufacturing reasons and in particular has a hollow housing interior, it is necessary that the housing or the plurality of housing parts is sealed against the ingress of these undesirable substances (grime, dirt, fluid media).

There may therefore be a need to provide a connector for a supply cable which is simple and cost-effective to produce, which is as small as possible, is lightweight, in particular has a hollow housing interior, is cost-effective and simple to Substitute Specification repair, and in which the housing interior is sealed as well as possible against dirt, grime, moisture and/or fluid media from an external environment of the connector, and whose function is not impaired by mechanical influences (e.g., jolt loads, pressure, thermal stresses, weight loads, shocks, vibrations or the like, e.g., falling from a height of 1 m to 1.5 m onto a concrete floor, vibrations which, for example, typically occur in motor vehicles, rolling over or driving over the connector with a vehicle, etc.).

This need can be met by the object of the present invention according to certain features of the present invention. Advantageous embodiments of the present invention are disclosed herein.

According to a first aspect of the present invention, a connector for a supply cable for electrically connecting a vehicle to a power supply device, which provides electric power, and/or to a load, which requires electric power, is provided.

According to an example embodiment of the present invention, the connector has a housing with a housing interior. It also has a printed circuit board and a holding element. The housing has an inner wall, which delimits the housing interior, wherein the inner wall has a first portion and a second portion opposite the first portion, wherein the holding element has an elastically reversible material or is formed predominantly (more than 50%) or completely from an elastically reversible material, wherein the printed circuit board is mounted in the housing interior by means of the holding element.

The holding element can be a holding element for the printed circuit board. Alternatively or additionally, it can, for example, be provided that the holding element is configured to hold or mount the printed circuit board, in particular in a stationary manner.

For example, it can be provided that the printed circuit board is mounted in a clamped manner in the housing interior by means of the holding element. In this case, the holding means itself can bring about the clamped mounting (by itself). However, it can also be provided that a plurality of holding means cooperate to bring about the mounting, in particular a clamped mounting.

It can, for example, be provided that the printed circuit board is held in place in the housing (in all spatial directions) exclusively by the holding element, e.g., by means of clamped mounting, i.e., that it is not (additionally) held by other or other types of holding means, e.g., not by means of (additional) screwing, gluing, clipping, etc.

This has the advantageous effect that the intensity of mechanical influences, in particular jolts, vibrations and/or other mechanical loads (e.g., tensions due to the application of pressure if the connector is subjected to a weight, for example; mechanical loads (tensions) due to thermal expansion; tensile or compressive loads due to lines running in the housing interior; etc.) on the printed circuit board is reduced or damped. In this way, the risk of the printed circuit board being damaged or of loss of functionality occurring in the case of such mechanical stresses, which, for example, act on the housing from the surroundings or the external environment of the housing, is reduced. Furthermore, mounting the printed circuit board by means of the holding element advantageously means that repairs to the connector and/or the printed circuit board can be carried out particularly simply and cost-effectively, thereby advantageously increasing the sustainability of the connector. This is in particular true in the case of clamped mounting of the printed circuit board. Furthermore advantageously, the mounting of the connector can be carried out particularly simply and cost-effectively by mounting the printed circuit board by means of the holding element: (Additional) stationary fixing of the printed circuit board in the housing by means of other connecting means, such as screws, clip connections, adhesive, hardening plastics, etc., is advantageously not required. This can advantageously save process steps during assembly and disassembly, as well as material. The assembly and disassembly are advantageously simplified. The holding element can advantageously perform a plurality of functions simultaneously: It ensures a stationary positioning or holding of the printed circuit board in the housing interior and at the same time provides a damping function or decoupling function for reducing the intensity of mechanical loads, which, for example, act on the housing from outside or originate from the housing interior, on the printed circuit board. This multiple function means that additional components, such as damping elements that have to be produced or installed separately to reduce shock intensity, can be saved. This advantageously further simplifies the assembly. The risk of incorrectly installing such separate damping elements (e.g., forgetting or incorrectly installing them) is also advantageously reduced, and quality control is simplified. Particularly advantageously, the housing can be manufactured without foaming and/or potting so that, despite good sealing (e.g., protection class IP55, IP65, IP57, IP67 or even better) and shock resistance, the connector is lightweight and the connector is also simple to repair. The housing interior is thus advantageously a hollow housing interior. Furthermore advantageously, potting of the printed circuit board can also advantageously be dispensed with due to the damping achieved, and nonetheless, due to the damping or mechanical decoupling achieved, the shock resistance, pressure resistance and vibration resistance of the printed circuit board and of the components arranged on it can, for example, be ensured (with respect to such effects on the housing).

Preferably, according to an example embodiment of the present invention, an acceleration load which acts on the housing, for example when the connector falls from a height of 1 m to 1.5 m onto a concrete floor, is damped by the mounting of the printed circuit board by means of the holding element by at least 20% with respect to the printed circuit board, preferably by at least 50% and particularly preferably by at least 75%.

The term “mounting” or “clamped mounting” or the term “mounted” or “mounted in a clamped manner” can be understood to mean, for example, that the printed circuit board is fixed in one or more, in particular in all, spatial directions in the housing interior, e.g., between two housing shells of the housing, due to the (clamped) mounting, and is thus in particular stationary. A slight mobility due to the elastically reversible design of the holding element does not conflict with the, for example clamped, mounting (or even a stationary mounting).

According to an example embodiment of the present invention, the housing can, for example, be made of or comprise one or more plastics material(s), such as polyamide (PA), polypropylene (PP) and/or rubber, natural rubber, silicone, thermoplastic elastomers, thermoplastic polyamide elastomers, thermoplastic copolyester elastomers, urethane-based thermoplastic elastomers or materials with similar physical effect. The plastics material(s) can be filled with glass fiber, e.g., PA6 GF30 or PA6 GF35 or the like. In principle, it is also possible that the housing comprises or is made predominantly from metal, wood, ceramic or another material.

The printed circuit board can, for example, comprise an electrical and/or electronic circuit.

The printed circuit board can, for example, be a single-layer, two-layer or more than two-layer printed circuit board (e.g., three or four or even more layers). It can be an FR4, FR5, polyimide or Teflon printed circuit board. In principle, the use of a ceramic printed circuit board or other types of printed circuit boards is also possible.

The printed circuit board can, for example, be arranged in the housing interior. It can, for example, be arranged completely in the housing interior. In this case, it is particularly well protected against dirt, grime and moisture or other fluid media from the external environment of the housing and also particularly well protected against mechanical stress or influences from the external environment of the housing.

The printed circuit board can, for example, comprise an SMD component. It can in particular be equipped in such a way that the plurality of the components arranged on the printed circuit board are SMD components. In this way, the printed circuit board can be built particularly small, which means the connector is smaller and can be manufactured to be lighter in weight. By the, for example merely clamped, mounting of the printed circuit board by means of the holding element, the risk of damage to the electrical function (e.g., due to breakage of solder joints) of the at least one SMD component is advantageously reduced.

The printed circuit board can, for example, be equipped on both sides. For example, it can be provided that at least one SMD component is arranged on each side of the printed circuit board; in particular, the plurality of the components on each side can be designed as SMD components. In this way, a great deal of installation space can advantageously be saved. The damped mounting (shock absorption) by means of the holding element thus makes a reduction in the size of the printed circuit board possible, in particular compared to the exclusive assembly of or equipping with THT components.

It can, for example, be provided that the printed circuit board has at least one voltage converter, in particular designed as an SMD component, wherein the voltage converter generates a (low) voltage in the range of 7 V to 25 V from a mains voltage applied to the connector. It can be provided that the low voltage provided in this way can be used, for example, to switch a bypass switch or a relay. Such a voltage converter can, for example, have a mass of at least 5 g, preferably of at least 15 g, e.g., a mass in the range between 10 g and 50 g.

For example, it can be provided that the printed circuit board has at least one relay. Said relay can, for example, be designed as a THT component or as an SMD component. The relay can, for example, be designed to activate or deactivate an electrical current of a power supply device or of a vehicle, so that the current can, for example, flow from a connection side of the connector to a line connection on a line side of the connector, or vice versa (activated first state of the relay), or cannot flow (deactivated second state of the relay). In this case, the relay can, for example, be designed to switch when a voltage in the range of 40 V to 1000 V is applied, preferably in the range between 70 V and 450 V, and more particularly preferably in the range of 90 V to 390 V. Such a relay can, for example, have a mass of at least 5 g, preferably of at least 15 g, e.g., a mass in the range between 10 g and 50 g.

It can, for example, be provided that the printed circuit board has dimensions in which a length is at least 2 cm and is, for example, in a range between 2 cm and 15 cm, preferably, for example, in a range between 4 cm and 13 cm, and in which a width is at least 1.5 cm and is, for example, in a range between 1.5 cm and 10 cm, preferably in a range between 2.5 cm and 8.5 cm.

The mounting of the printed circuit board by means of the holding element in particular in a damping and/or shock-absorbing and/or housing-decoupling manner, for example in a clamped manner, advantageously makes it possible to mount the relatively heavy components described above (such as relays and/or voltage converters) as SMD components on the printed circuit board, although a design as a THT component is also possible. The risk of damaging the function of such components, e.g., by detachment from the printed circuit board, is advantageously significantly reduced due to the holding element. Furthermore, the risk of damage to the component itself can also be reduced by the mounting of the printed circuit board by means of the holding element. The resulting damping can, for example, prevent a coil arranged inside a relay from striking the relay housing, and can thus counteract a loss of function of the relay.

For example, it can be provided that the printed circuit board is mounted exclusively in its edge region by means of the holding element. The edge region can, for example, extend in a strip of up to a maximum of 5 mm from the edge of the printed circuit board into the interior of the printed circuit board, preferably in a strip of at most 3 mm. This makes it advantageously possible to use a particularly large surface area of the printed circuit board for equipping it with electronic or electrical components or elements.

According to an example embodiment of the present invention, it can be provided that the printed circuit board is mounted at exactly one point. However, it can also be mounted by means of the holding element at a plurality of points, e.g., at two, three, four, five, six or even more points. Preferably, it is held at three or four points. The points may preferably be spaced apart from one another. They can preferably be arranged with respect to the plane of the printed circuit board such that at least two points are arranged on opposite sides of the printed circuit board. For example, it can be provided that the printed circuit board is mounted in a clamped manner at a maximum of 10% of its total surface area, preferably at a maximum of 5% of its total surface area, which advantageously increases the surface area of the printed circuit board that can be equipped.

According to an example embodiment of the prsent invention, it can be provided that the housing interior is sealed by means of a sealing element. This, for example, also advantageously protects the printed circuit board from dirt, grime and moisture from the external space or the external environment of the housing.

It can, for example, be provided that the housing interior is hollow, i.e., it is in particular not foamed or the printed circuit board or other electrically, electronically or optically functional elements are not overmolded in the housing interior. This advantageously makes it possible to repair the connector particularly simply, and the connector can be made particularly lightweight.

A holding element can be considered to be, for example, an element that can hold or mount the printed circuit board, can mount it in a stationary manner, can fasten it, in particular in the housing interior. The holding element proposed here, which comprises an elastically reversible material or is made of such a material (at least predominantly), has a damping function in addition to the holding function for the printed circuit board. The mounting can, for example, be frictional, force-fitting or form-fitting. For example, the printed circuit board can have an excess in at least one spatial direction or in at least one dimension (e.g., in a range between 0.2 mm and 4 mm, preferably between 0.4 mm and 2 mm) compared to a dimension of the holding element or compared to a dimension which is defined by a plurality of holding elements (e.g., a distance between two holding elements along a spatial direction).

It can, for example, be provided that the holding element mounts the printed circuit board in a stationary manner only in the fully mounted state of the housing, e.g., in the case of a multi-part housing. Thus, with regard to the mounting, the mounted state of the housing should in particular be assumed. In order to achieve the mounting effect, the holding element can, in turn, interact with the housing, e.g., by supporting itself on the inner wall.

It is understood that the connector can have exactly one single holding element. However, it can also have a plurality of holding elements, e.g., two, three, four, five, six, seven, eight or even more holding elements.

The holding element can, for example, be designed as a claw or a mouth. For example, it can have an insertion funnel. This advantageously results in a particularly simple and securely positioned coupling of the printed circuit board with the holding element or a particularly simple and securely positioned mounting of the printed circuit board at, in or on the holding element.

The holding element can, for example, have a damping distance or a spacing from the mounting position (of the printed circuit board) to the inner wall or to a point at which the holding element is connected to a part of the housing, which distance or spacing is, for example, at least 1 mm, preferably at least 2 mm, and which is, for example, in a range between 1 mm and 25 mm, preferably in a range between 1.5 mm and 15 mm, and more particularly preferably in a range between 2 mm and 8 mm.

The first portion of the inner wall and the second portion of the inner wall can, for example, be opposite one another with respect to a longitudinal direction of the housing (for example, they can be arranged on both sides of a longitudinal axis through the housing interior). The housing can, for example, extend along a longitudinal axis or longitudinal direction (e.g., between a connection side and a line side), which can also be curved (following a possible housing curvature between the connection side and the line side). In this case, a connection element, e.g., a household plug connector or a so-called type 2 connector or the like, can be arranged on the connection side, wherein it is also possible for the plug face to point outward transversely to the longitudinal direction or longitudinal axis.

It can, for example, be provided that the printed circuit board is mounted exclusively by the at least one holding element in the housing interior, e.g., in a clamped manner. In this case, accordingly, no additional connecting means is required for the (stationary) mounting of the printed circuit board in the housing interior, e.g., no screws, no clips, etc.

In the context of this application, the term “having” is used synonymously with the term “comprising” and the term “have” is used synonymously with the term “comprise,” unless otherwise specified.

In a development of the present invention, it is provided that the printed circuit board is mounted in the housing interior by means of the holding element in such a way that the printed circuit board is mechanically decoupled from the housing.

This has the advantageous effect that shocks and/or vibrations and/or pressure loads, etc. acting on the housing are not transmitted directly to the printed circuit board, thereby increasing the service life of the printed circuit board or the functionality of an electrical and/or electronic circuit of the printed circuit board.

In this case, the holding element is (at least functionally) not to be considered part of the housing or the inner wall of the housing. If the holding element is formed as a single piece with the housing or the inner wall, the printed circuit board is still mechanically decoupled from the housing since the holding element has a damping function. The mechanical decoupling of the printed circuit board from the housing or the inner wall is achieved in that mechanical influences on the housing from an external environment or an external space of the housing (such as shocks and/or vibrations and/or pressure) are transmitted to the printed circuit board only in a damped manner (e.g., by at least 20%, preferably by at least 50%) by means of the holding element. In other words, if the printed circuit board were coupled to the housing with a connecting element instead of the holding element, wherein the connecting element would correspond in shape to the holding element but would be made of a rigid or significantly more rigid or stiffer material than the holding element (i.e., for example, would be made of the material of the inner wall of the housing), there would be no or only insignificant damping (e.g., less than 20%) of such mechanical influences from the housing on the printed circuit board.

Alternatively or additionally, according to an example embodiment of the present invention, it is provided that the printed circuit board is mounted in the housing interior by means of the holding element in such a way that the printed circuit board has no direct mechanical contact with the inner wall of the housing or with elements that are formed in one piece with the inner wall of the housing.

This has the advantageous effect that the printed circuit board is optimally mechanically decoupled from the housing. This advantageously prevents transmission of (undamped) mechanical influences from the inner wall or from the housing to the printed circuit board. This advantageously increases the service life of the printed circuit board and/or a circuit on the printed circuit board. This can advantageously increase the service life of the connector.

As explained above, it can be provided that the holding element is not considered part of the inner wall.

In a development of the present invention, it is provided that the holding element mounts the printed circuit board laterally on one side of the printed circuit board.

This has the advantageous effect that the printed circuit board has a particularly large, continuous assembly area. Another advantage is that the printed circuit board can be mounted particularly simply in the housing interior in this way. In the case of lateral mounting, a small overlap (an edge region of, for example, less than 3% of the printed circuit board surface) can be provided by the holding element.

The lateral mounting refers in particular to the end faces of the printed circuit board, which are directed radially outward with respect to the printed circuit board surface or printed circuit board plane and run around the (equippable) printed circuit board plane.

For example, it can be provided that the holding element mounts the printed circuit board exclusively laterally. In this case, the printed circuit board, for example, does not rest flat on a holding element that is largely or completely covered by the printed circuit board surface.

It can, for example, be provided that the holding element does not reach through a through-opening, in particular not through a through-opening arranged in the printed circuit board surface, of the printed circuit board (such a through-opening has a radially inward directed edge), but rather mounts the printed circuit board laterally. This advantageously simplifies assembly and disassembly of the printed circuit board in the housing interior. In addition, the equippable printed circuit board surface is not interrupted by such a through-opening, which, for example, considerably simplifies the layout for conductor tracks that can be arranged in and/or on the printed circuit board.

According to an example embodiment of the present invention, it can be provided that the printed circuit board is mounted by the holding element on more than one side. It can also be provided that the printed circuit board is coupled to at least one holding element each on at least two sides (e.g., two, three or four sides) of the printed circuit board. For example, it can be mounted in a clamped manner between a plurality of holding elements.

In a development of the present invention, it is provided that the holding element has a recess, wherein the printed circuit board is arranged with a printed circuit board edge in the recess.

This makes the printed circuit board particularly simple to mount. During mounting, it is, for example, simple to carry out a haptic and/or optical check to see whether the printed circuit board is correctly coupled to the holding element. Furthermore advantageously, the printed circuit board can thereby be mounted in a stationary manner in a plurality of spatial directions at the same time. This also makes it simple to damp mechanical action from the housing on the printed circuit board in a plurality of spatial directions.

The recess can, for example, be designed as a slot or as a holding element groove.

The printed circuit board can, for example, be mounted in the recess in a clamped manner.

The printed circuit board can be inserted laterally into the recess, for example. The holding element can then, for example, hold the printed circuit board in a clamped manner by means of the bottom of the recess in the printed circuit board plane and mount the printed circuit board in a clamped manner with the walls of the recess, in a direction parallel to the surface normal of the printed circuit board plane. The recess can, for example, be designed in such a way that the printed circuit board is mounted laterally and the walls of the recess only mount the edge of the printed circuit board to a small extent (e.g., at most 3% of the printed circuit board surface and/or, e.g., at most up to a distance of 3 mm from the lateral end face into the interior of the printed circuit board surface).

In a development of the present invention, it is provided that the holding element is arranged in or on the inner wall or in the housing wall.

This results in a particularly simple manufacture of the housing and/or the connector together with the holding element, e.g., in an injection molding process, or a simple connection of the holding element to the housing. The mounting of the printed circuit board in the housing interior is also advantageously simplified by the holding element arranged in or on the inner wall or in or on the housing wall. This advantageously eliminates the need to mount the printed circuit board (by means of the holding element) to other elements of the connector. Such other elements can, for example, be: contacts (e.g., on male contacts or female contacts protruding into the housing interior); supply lines to the printed circuit board or to the contacts; a connection element, which is accommodated or enclosed by the housing and can, for example, represent a mechanical interface to an infrastructure mating connector, a vehicle mating connector, etc.

Alternatively or additionally, according to an example embodiment of the present invention, it is provided that the holding element extends through the inner wall or the housing wall from an external environment of the connector into the housing interior.

This advantageously allows the holding element to be manufactured separately from the housing part having the inner wall or the housing wall, for example from a different material. It can subsequently advantageously be simply mounted on the housing and seal the housing or a hole through the housing that is necessary for mounting. In principle, it is also possible that the holding element is not designed as an initially separate element that can then be mounted on the housing, but rather that the holding element is formed in one piece with the housing, for example by being molded onto the initially manufactured housing or housing element in a two-component injection molding process. The design that extends through the housing ensures a particularly stable and permanent arrangement of the holding element on the housing.

The holding element can, for example, simultaneously seal the housing interior against the external environment in the case of such a penetration, thereby advantageously eliminating the need for an additional seal in the penetration opening.

In a development of the present invention, it is provided that the connector has at least one holding element on the first portion or in the first portion of the inner wall, wherein the connector has at least one holding element on the second portion or in the second portion of the inner wall, wherein the printed circuit board is mounted on two opposite printed circuit board sides between the holding elements of the first portion and of the second portion in the housing interior.

This advantageously provides a particularly secure, stationary mounting of the printed circuit board in the housing interior. For example, a two-point mounting can be formed, in which only exactly one holding element is arranged in the first and second portions. For example, a particularly stable three-point mounting can also be formed, in which two holding elements are arranged in the first portion and only a single holding element is arranged in the second portion (or vice versa). Four-point mounting or mounting with even more holding elements is also possible. The lateral mounting allows a particularly large surface area of the printed circuit board to be equipped or used for functional purposes (e.g., also for providing electrical terminals).

As explained above, printed circuit board sides are to be understood in particular as the end faces of the printed circuit board that face radially outward and in particular cannot be equipped (in the case of a rectangular printed circuit board, there are therefore four such end faces which are aligned transversely to the surface normal of the printed circuit board plane).

The printed circuit board can, for example, be clamped in or mounted in a clamped manner between the holding elements in the first or second portion, for example. This makes assembly and disassembly (e.g., for repair purposes) particularly simple.

In a development of the present invention, it is provided that the housing has a first housing shell and a second housing shell, wherein the housing interior is enclosed by the first housing shell and the second housing shell, wherein the first housing shell comprises the first portion of the inner wall, wherein the second housing shell comprises the second portion of the inner wall.

This advantageously makes it particularly simple and cost-effective to mount the printed circuit board in the housing interior and to remove it from the housing, e.g., for maintenance purposes or for repairs, which improves the durability of the connector (e.g., a defective printed circuit board and/or a defective housing shell can be replaced in a simple manner). For example, during mounting, the printed circuit board can first be mounted or placed in or on the first housing shell. The second housing shell can subsequently be coupled or connected to the first housing shell or fastened to the first housing shell to form the housing interior.

The holding element can, for example, be arranged on or in the first housing shell and/or on or in the second housing shell. Exactly one holding element or a plurality of holding elements can also be provided in each housing shell.

According to an example embodiment of the present invention, it can also be provided that the holding element extends through the first housing shell and/or the second housing shell from the external environment and is arranged in the region of the first or second portion of the inner wall.

The second housing shell can, for example, be formed separately from the first housing shell. In principle, it is also possible to design the first housing shell and the second housing shell in one piece (i.e., they cannot be separated from one another in a non-destructive manner). In such a case, the first housing shell and the second housing shell can be connected to one another by a film hinge, for example.

The first housing shell and/or the second housing shell can, for example, be made of or comprise one or more plastics material(s), such as polyamide (PA), polypropylene (PP). The plastics material(s) can be filled with glass fiber, e.g., PA6 GF30 or PA6 GF35 or the like. In principle, it is also possible that at least one of the housing shells comprises or is predominantly made of metal, wood, ceramic or another material.

In a development of the present invention, it is provided that the housing has a third housing shell, wherein the third housing shell is arranged at least in portions on a first outer side of the first housing shell, wherein the holding element is formed in one piece with the third housing shell and protrudes into the housing interior.

This has the advantageous effect that the housing can have different functional portions and can thus be optimized for the intended application. For example, the first housing shell can be made of a relatively hard, dimensionally stable material (e.g., PA or PE or the like, possibly also filled with glass fiber), which gives the housing high mechanical stability. The third housing shell can, for example, be made of a relatively soft material, which is pleasant and simple to grip for an operator, still feels warm and soft even at cold ambient temperatures of, for example, −20° C. or −40° C., damps the impact energy if the connector falls, etc. The design of the holding element with the third housing shell can advantageously reduce the effort involved in the production of the housing. This can also advantageously result in a more durable connection between the first housing shell and the third housing shell. This advantageously increases the service life of the housing and thus its sustainability.

Alternatively or additionally, it is provided that the housing has a fourth housing shell, wherein the fourth housing shell is arranged at least in portions on a second outer side of the second housing shell, wherein the holding element is formed in one piece with the fourth housing shell and protrudes into the housing interior.

For the fourth housing shell (and the second housing shell), the advantages described above with regard to the combination of the first and third housing shell apply analogously.

The third and/or the fourth housing shell can, for example, comprise or be formed, in particular to more than 50%, from a material selected from the group: rubber, natural rubber, silicone, thermoplastic elastomers, thermoplastic polyamide elastomers, thermoplastic copolyester elastomers, urethane-based thermoplastic elastomers or materials having a similar physical effect.

In a development of the present invention, it is provided that the housing has a first support element in the first portion, which support element faces the second portion, wherein the first support element is spaced apart from the second portion and/or from a second support element of the second portion in the force-free state of the housing.

The spacing has the advantageous effect that, when assembling the housing from the first and second housing shells, the two housing shells can always be assembled together firmly, tightly (e.g., by interposing a sealing element), without gaps, etc., regardless of manufacturing tolerances, to form the housing. In the force-free state (in which the connector is handled by a user, for example) of the assembled housing, the first support element thus does not come into contact with another element in the housing interior and thus does not go “solid.” At the same time, the (preferably only small) spacing has the advantageous effect that (in particular static) forces acting on the housing along the printed circuit board plane (e.g., when a vehicle rolls over the connector) and compressing the housing are diverted via the first support element (as well as the second portion or the second support element). Such forces therefore do not act on the printed circuit board. In this way, the printed circuit board is advantageously protected against damage due to mechanical influences. Furthermore, the first support element advantageously protects the housing, in particular with its, for example hollow, housing interior (but also with a housing interior filled or foamed, for example with soft and/or porous material), from collapsing when subjected to external force.

For example, it can be provided that the first support element extends substantially (+/−30°) in parallel with a printed circuit board plane. This provides particularly secure support for the housing in its housing interior and particularly good protection against damage to the printed circuit board if a force is applied (substantially) in parallel with the printed circuit board plane. In this case, the printed circuit board plane is preferably to be considered the plane on which the components of the printed circuit board are fitted.

It can, for example, be provided that the spacing between the first support element and the second portion and/or second support element is in a range between 0.05 mm and 4 mm, preferably in a range between 0.1 mm and 2 mm. In this way, the spacing is large enough on the one hand to make a sufficiently good assembly of the housing shells to form the housing possible even in the case of manufacturing tolerances of the housing shells (e.g., while maintaining small gap dimensions, high tightness, etc.) and at the same time to support the housing interior by means of the first support element even in the case of relatively small forces acting on the housing and thus to prevent (excessive) force introduction into the printed circuit board and/or a collapse of the housing interior.

Alternatively or additionally, it is provided that the housing has a second support element which faces the first portion, wherein the second support element is spaced apart from the first portion or from a first support element of the first portion in the force-free state of the housing.

The advantages described above with respect to the first support element apply analogously to the second support element.

The second support element can, for example, extend substantially (+/−30°) in parallel with the printed circuit board plane.

The spacing between the second support element and the first portion and/or the first support element can, for example, be in a range between 0.05 mm and 4 mm, preferably in a range between 0.1 mm and 2 mm.

It is understood that exactly one first support element or exactly one second support element can be provided. However, a plurality of first or second support elements (e.g., two or three or four or five or even more first or second support elements) may also be provided. It is understood that the mutually facing end faces of the housing shells (between which a sealing element can also be arranged, for example) are preferably not considered as the first or second support element.

In a development of the present invention, it is provided that the spacing between the first support element and the second portion and/or the second support element is designed such that, when a force of more than 1000 N, preferably more than 500 N, particularly preferably more than 200 N, and more particularly preferably more than 100 N is applied to the housing along the printed circuit board plane, the first support element comes into mechanical contact with the second portion and/or the second support element.

This has the advantageous effect that the printed circuit board is protected from excessive external forces acting on the housing or is decoupled in that such forces are diverted via the first support element and/or the housing. At the same time, the housing is protected from being deformed (too much) or even collapsing under such forces. This advantageously protects the (in particular hollow) housing interior from temporary or permanent leaks, e.g., due to housing shells gaping apart and/or damage to a sealing element arranged between the housing shells.

Alternatively or additionally, according to an example embodiment of the present invention, it is provided that the spacing between the second support element and the first portion and/or the first support element is designed such that, when a force of more than 1000 N, preferably more than 500 N, particularly preferably more than 200 N, and more particularly preferably more than 100 N is applied to the housing along the printed circuit board plane, the second support element comes into mechanical contact with the first portion and/or the first support element.

The advantages described above with respect to the first support element apply analogously to the second support element.

In a development of the present invention, it is provided that the holding element comprises or is formed, in particular to more than 50%, from a material selected from the group: rubber, natural rubber, silicone, thermoplastic elastomers (TPE), thermoplastic polyamide elastomers (TPE-A), thermoplastic copolyester elastomers (TPE-C), urethane-based thermoplastic elastomers (TPE-U) or materials that have a similar physical effect.

This results in a particularly good mechanical decoupling of the printed circuit board from the housing and a particularly good damping of mechanical influences on the printed circuit board, in particular even in the case of small damping distances or of small dimensions of the holding element. Furthermore advantageously, in this way, particularly simple and cost-effective manufacturing of the holding element, and thus of the connector, is achieved. For example, the holding element can be produced in an injection molding process.

Alternatively or additionally, according to an example embodiment of the present invention, it is provided that the holding element has a Shore A hardness of at most 60, preferably of at most 50, particularly preferably of at most 45.

This advantageously results in particularly good damping of mechanical influences on the printed circuit board, even in the case of only small dimensions of the holding element (e.g., short damping distance).

In a development of the present invention, it is provided that the connector is configured to be electrically connected to a household socket or a mating connector of a vehicle (e.g., type 1, type 2, combo, CHAdeMO, Tesla Supercharger, household plug, CCE terminal or the like) or to a mating connector of a power supply device (e.g., type 1, type 2, combo, CHAdeMO, Tesla Supercharger, household plug, CCE terminal or the like).

This makes it possible that the connector, for example in the manner of a charging plug, can provide a charging cable or a supply cable, by means of which a motor vehicle can, for example, be charged by means of current from various infrastructure terminals or by means of which current from a vehicle can be provided to an electrical load. In this case, due to its low weight and the shock-absorbing mounting or the mounting of the printed circuit board that is mechanically decoupled from the housing, the connector can take on functions that would otherwise be carried out in an ICCB (in-cable control box) arranged outside the connector in the connecting line. The connector can therefore advantageously make the provision of a particularly lightweight, space-saving and cost-effective supply cable possible while meeting all necessary sealing and shock resistance requirements.

In a development of the present invention, it can be provided that the first (and/or second) housing shell has a guide structure for mounting the printed circuit board in or on the first (or second) housing shell, wherein the guide structure protrudes from the first (and/or second) portion of the inner wall in the direction of the second (or first) housing shell.

The guide structure can, for example, be designed to couple the printed circuit board to the holding element or to insert it into the holding element during assembly in the housing interior by means of the guide structure. The guide structure and the holding element can, for example, be designed relative to one another in such a way that, in a (force-free) state of the connector, in which the printed circuit board is coupled to the holding element or is held by the holding element, there is no (longer any) mechanical contact between the guide structure and the printed circuit board.

This advantageously results in a particularly simple and securely positioned mounting of the printed circuit board on or in the holding element, or a particularly simple and securely positioned coupling or mounting between the holding element and the printed circuit board.

In a development of the present invention, it can be provided that the first (and/or second) housing shell has a first (or second) stop, which protrudes from the first (or second) portion of the inner wall in the direction of the printed circuit board, in particular by at least 0.5 mm, preferably by at least 1 mm, and more particularly preferably by at least 2 mm, wherein the first (or second) stop is spaced apart from the printed circuit board in the force-free state of the connector, in particular by at least 0.5 mm, preferably by at least 1 mm, particularly preferably by at least 2 mm.

As a result, when the connector is in the force-free state and/or when the connector is subjected to minor mechanical action (e.g., vibrations during normal vehicle travel or falls from a height of less than 25 cm or less than 50 cm), the stop advantageously cannot transmit any mechanical influences to the printed circuit board through direct contact with said printed circuit board (e.g., no vibrations, shocks, etc.). In these cases, the printed circuit board is mounted (preferably exclusively) by the holding element or the plurality of the holding elements. At the same time, this has the advantageous effect that, in the event of a permanent high force action (e.g., rolling over the connector or storing the connector under a large weight, i.e., for example, forces greater than 100 N or greater than 200 N or greater than 500 N or greater than 1000 N) and/or short-term very high force action (e.g., falling from a height of more than 1 m or more than 1.5 m), the printed circuit board can come to rest on the first (and/or second) stop, thereby preventing plastic (no longer reversible) deformation of the holding element. Furthermore, the stop can advantageously prevent the printed circuit board from pushing the holding element (possibly together with the third and/or fourth housing shell) out of the housing interior if the holding element is designed such that it extends through the housing from the external environment into the housing interior. This makes it possible, for example, to dispense with a complex shaping of the holding element, in which the holding element must, for example, have a positive rear grip in the region of the housing interior in order to prevent such pushing through. This advantageously facilitates the production of the connector.

According to a second aspect of the present invention, a supply cable for electrically connecting a vehicle to a power supply device, which provides electric power, and/or to a load, which requires electric power, is provided.

The supply cable has a connector of the present invention as described above. It furthermore comprises a connecting line, which is or can be electrically connected to the connector. It may furthermore comprise a further connector, which is or can be arranged at another end of the connecting line.

This advantageously provides a particularly cost-effective, lightweight, simple to produce, simple to repair, stable and reliable charging cable.

### BRIEF DESCRIPTION OF THE DRAWINGS

Further features and advantages of the present invention will become apparent to a person skilled in the art from the following description of exemplary embodiments, which, however, are not to be interpreted as limiting the present invention, with reference to the figures.

FIG. 1 is a schematic illustration of a supply cable;

FIG. 2 is a schematic cross-section through a printed circuit board arrangement in a connector from the related art.

FIG. 3 is a schematic exploded view of a connector of the supply cable, according to an example embodiment of the present invention.

FIG. 4A is a schematic cross-section through a connector of the supply cable, according to an example embodiment of the present invention.

FIG. 4B is a detail view of the connector of FIG. 4A, before the printed circuit board is mounted by the holding element.

FIG. 4C is a detail view of the connector of FIG. 4A, with the printed circuit board mounted by the holding element.

FIG. 5 is a schematic perspective and partially opened plan view of the connector of FIG. 4A.

FIG. 6A is a schematic perspective view of a first and third housing shell, according to an example embodiment of the present invention.

FIG. 6B is a schematic perspective view of the third housing shell of FIG. 6A.

FIG. 6C is a schematic perspective external view of the housing of a connector with a first, second, third and fourth housing shell.

### DETAILED DESCRIPTION OF EXAMPLE EMBODIMENTS

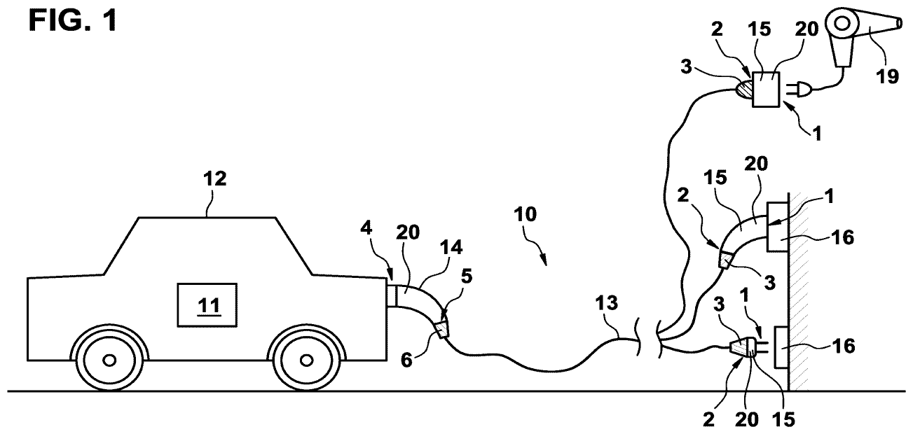

FIG. 1 schematically shows a vehicle 12, which is, for example, a hybrid or electric vehicle and has an energy store 11. The energy store 11 is to be charged here, for example, via a power supply device 16. The power supply device 16 in the case shown in FIG. 1 can, for example, be a wall box that makes charging with a three-phase alternating voltage possible, or a continuous voltage source, for example a household socket, such as a Schuko socket, which makes single-phase charging possible, for example. A supply cable 10 is provided for connecting the power supply device 16 and the energy store 11 or vehicle 12.

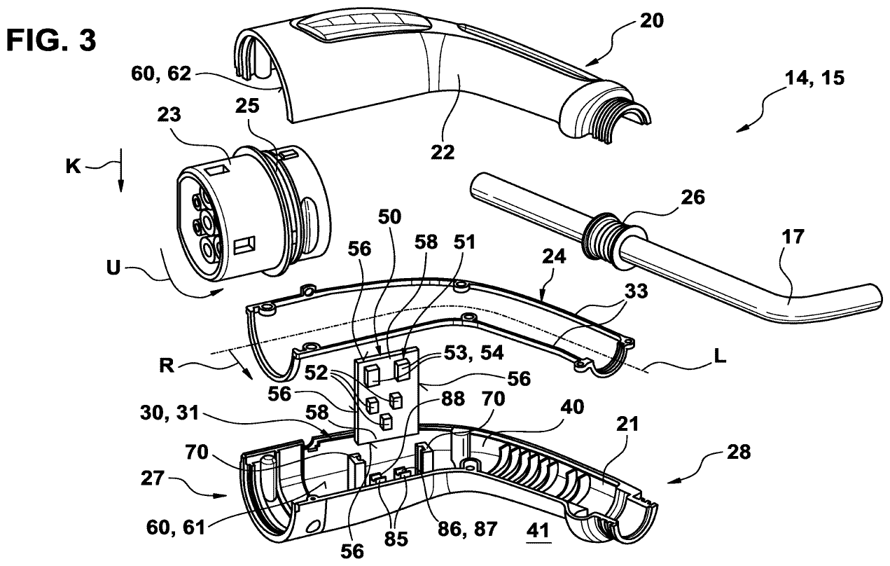

The supply cable 10 has a primary connector 14 and a secondary connector 15, different variants of the secondary connector 15 being shown in FIG. 1. In the context of the application, reference is generally made to connector 14, 15. For the sealing concept and for the mounting of a printed circuit board 50 (see, e.g., FIG. 3) of the connector 14, 15, it is not important whether it is a primary connector 14 or a secondary connector 15. However, to make the application text easier to understand, the connector 14, 15 may occasionally be specified more precisely as primary connector 14 or secondary connector 15. There is a supply line or connecting line 13 between the (primary) connector 14 and the (secondary) connector 15. The (primary) connector 14 is used for electrical connection to the vehicle 12 and especially to the energy store 11. Depending on its design, the (secondary) connector 15 is used for connection to the various types of the power supply device 16 or a load 19. In the event that the (secondary) connector 15 is configured for connection to a load 19 (shown here by way of example in the form of a hair dryer), the (secondary) connector 15 can be a Schuko socket, for example. In this case, electric power is drawn from the vehicle 12 or its energy store 11. It is understood that the electrical load can also be a power grid so that electric power from the vehicle 12 can be fed back into the power grid. In this case, for example, a Schuko plug or a type 2 charging plug for plugging into a wall box can serve as a (secondary) connector 15. It is furthermore understood that the electrical load can also be another vehicle, which is supplied with current or electric power from the vehicle 12. In this case, the (secondary) connector 15 can be designed analogously to the (primary) connector 14, for example.

The (primary) connector 14 has a vehicle terminal 4, which is provided for indirect or direct detachable wireless or wired electrical connection to the vehicle 12 or the energy store 11.

In the embodiment shown, the (primary) connector 14 also has an additional terminal 5, via which a wireless and/or wired electrical connection can be established directly or indirectly in a detachable manner with an additional coupling 6 of the connecting line 13. In an alternative embodiment, the additional terminal 5 and the additional coupling 6 can be dispensed with so that the connecting line 13 is attached directly to the (primary) connector 14 and cannot be separated from it in a non-destructive manner.

In the exemplary embodiment shown, the supply cable 10 can be coupled to various types of (secondary) connectors 15. Each (secondary) connector 15 has an infrastructure terminal 1 and a cable terminal 2, wherein the infrastructure terminal 1 is designed for electrical connection to the power supply device 16 or the load 19. The cable terminal 2 is used to connect to the connecting line 13. For this purpose, the connecting line 13 has, for example, a coupling 3, wherein the coupling 3 and the cable terminal 2 can be electrically connected in a detachable manner. This means that the (secondary) connectors 15 can be replaced simply and with little effort by merely disconnecting the connection between the coupling 3 and the cable terminal 2. In principle, supply cables 10 in which the (secondary) connector 15 is connected to the connecting line 13 in a non-detachable (i.e., not non-destructively detachable) manner are, of course, also possible.

FIG. 1 shows, at the top right, that the infrastructure terminal 1 can also be designed, by way of example, for connection to a load 19, for example by designing the infrastructure terminal 1 or the (secondary) connector 15 as a Schuko socket or as a three-phase socket. FIG. 1 shows, at the center right, that the infrastructure terminal 1 of the (secondary) connector 15 in an alternative embodiment can, for example, be a type 2 terminal for connection to a charging column or wall box (in this case, a current flow from the infrastructure terminal 1 to the vehicle 12 or from the vehicle 12 to the infrastructure terminal 1 is possible, for example). FIG. 1 shows, at the bottom right, by way of example, that the infrastructure terminal 1 of the (secondary) connector 15 in an alternative embodiment can be a Schuko plug for connection to a household socket (here too, for example, a current flow from the infrastructure terminal 1 to the vehicle 12 or from the vehicle 12 to the infrastructure terminal 1 is possible). A (secondary) connector 15 for connecting to another vehicle is also possible in principle but is not shown here.

In this exemplary embodiment, the connecting line 13 only has electrical conductors between the coupling 3 and the additional coupling 6, which electrical conductors establish an electrical connection between the coupling 3 and the additional coupling 6. These electrical conductors are copper conductors or aluminum conductors, for example, or they are made of another material with high electrical conductivity and have electrical insulation. All electrical conductors are assembled in one strand, for example, and preferably have a common sheath that serves as electrical insulation on the one hand and mechanical protection on the other. Preferably, no active or passive electrical component is provided in the connecting line 13 in FIG. 1. All logic components or logic modules (e.g., microprocessors, ASICs, etc.) and in particular active or passive electrical components are either part of the (primary) connector 14 and/or part of the (secondary) connector 15. As a result, the connecting line 13 can advantageously be produced cost-effectively. An ICCB (in-cable control box) can therefore be expressly dispensed with in this exemplary embodiment. As a result, the supply cable 10 can be provided in a cost-effective, compact, simple, space-saving and lightweight manner, despite its adaptability shown here (various (secondary) connectors 15 can be connected as required). Dispensing with an ICCB reduces not only weight, costs and manageability but also time-consuming quality checks and load tests, because it is not necessary to secure the sensitive electronics of the ICCB, for example against being driven over by other vehicles, e.g., trucks. This also has the advantage of reducing the risk of people tripping. It is understood that in other exemplary embodiments, an ICCB can be provided, which is in this case arranged, for example, within the connecting line 13.

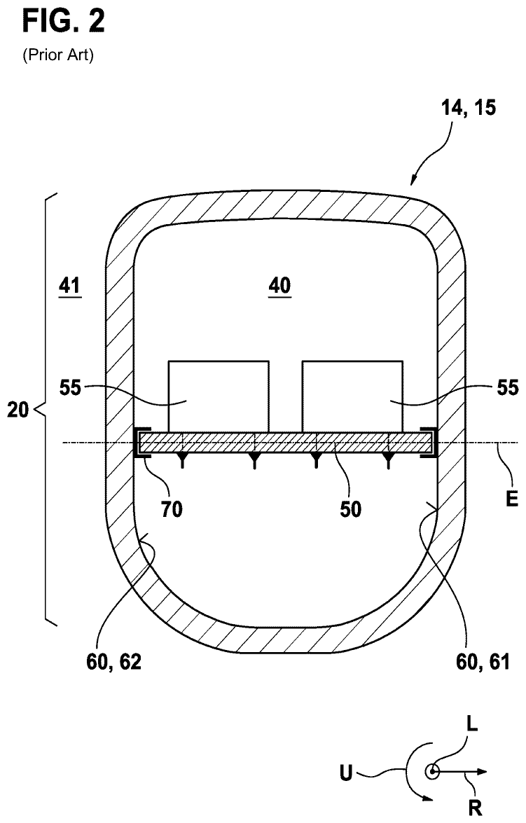

FIG. 2 shows a cross-section through a connector 14, 15 for a supply cable 10 from the related art. The connector 14, 15 has a housing 20, which encloses a housing interior 40. Outside the housing 20, there is an external environment 41, which can, for example, be the surroundings. A printed circuit board 50 is arranged in the housing interior 40. The printed circuit board 50 is arranged in two guide slots 70 on opposite inner walls of the housing 20 and is thus directly exposed to shocks or vibrations acting on the housing 20. The printed circuit board 50, shown schematically here, has two components, which are designed as THT components 55 (THT=through-hole technology).

FIG. 3 is a schematic exploded view of the (primary) connector 14, wherein a structure of the (secondary) connector 15 may be, but does not have to be, substantially analogous to that of the (primary) connector 14. In the following, no explicit distinction is made between a (primary) connector 14 and a (secondary) connector 15, but rather general reference is made to a connector 14, 15, which can thus be the (primary) connector 14 and/or (secondary) connector 15.

The connector 14, 15 can be suitable or designed for the electrical connection to a household socket and/or a mating connector of a vehicle 12 and/or to a mating connector of a power supply device 16 and/or to a load 19 requiring electric power. A type 2 connector is shown here by way of example, without the connector 14, 15 having to be limited to such a type.

The connector 14, 15 has a housing 20 with a housing interior 40. The housing interior 40 is here, by way of example, a hollow housing interior 40, i.e., it is not, in particular not predominantly or even completely, filled with a foam material or a plastics material. The housing 20 has an inner wall 60, which delimits the housing interior 40, wherein the inner wall 60 has a first portion 61 and a second portion 62 opposite the first portion 61.

In this exemplary embodiment, the housing 20 has at least a first housing shell 21 and a second housing shell 22, which is here, by way of example, separate from the first housing shell 21, wherein the housing interior 40 is enclosed by the first housing shell 21 and the second housing shell 22, wherein the first housing shell 21 has the first portion 61 of the inner wall 60, wherein the second housing shell 22 has the second portion 62 of the inner wall 60.

In principle, a one-piece design of the two housing shells 21, 22, for example connected by a film hinge or similar, is also possible.

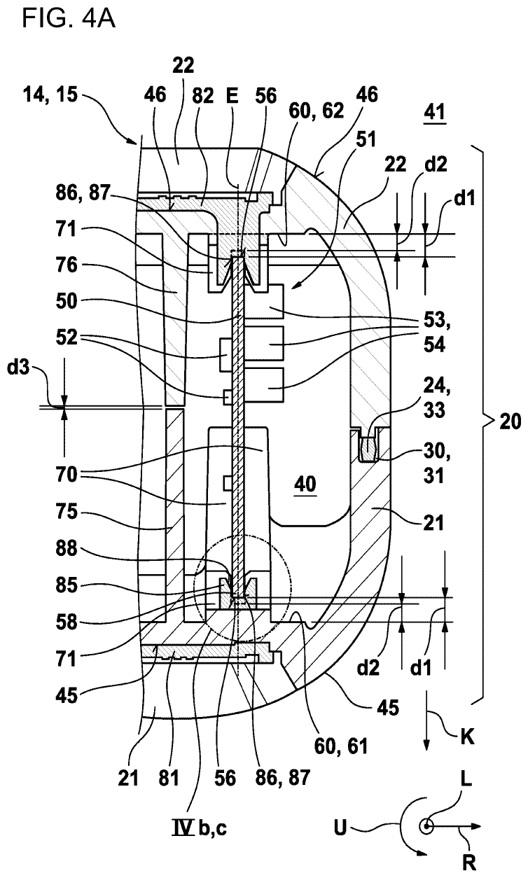

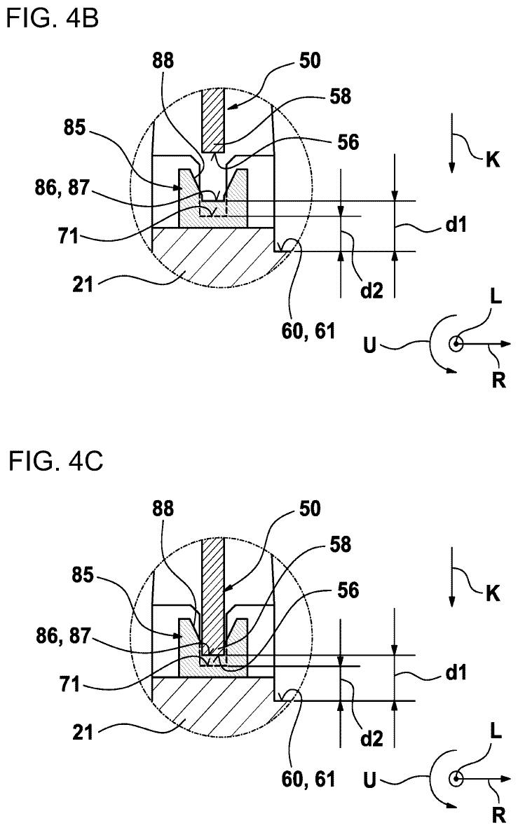

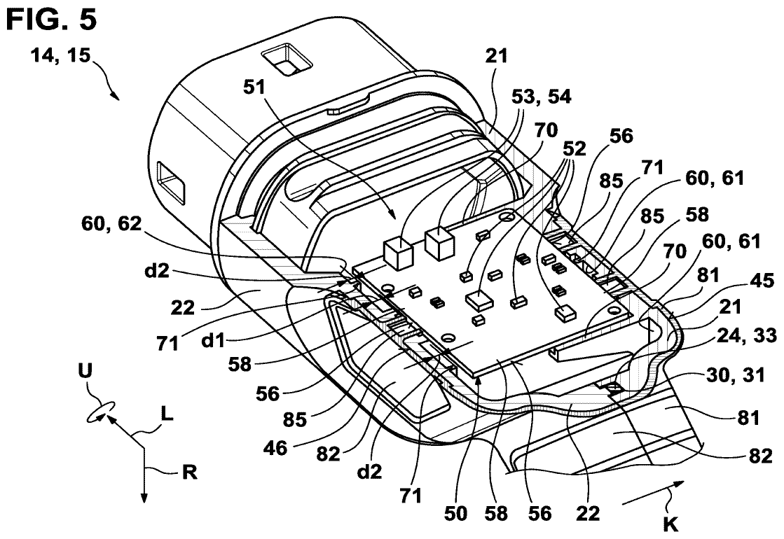

The connector 14, 15 also has a printed circuit board 50. This printed circuit board 50 has, for example, an electrical and/or electronic circuit 31. The connector 14, 15 furthermore comprises at least one holding element 85 for the printed circuit board, wherein, in FIG. 1, two holding elements 85 are shown visibly in the first portion 61 of the first housing shell 21; a further holding element 85 or a plurality of further holding elements 85 (not visible here, but see, for example, FIG. 4A, 5 for such exemplary embodiments) can be arranged in the second portion 62 of the inner wall 60. The at least one holding element 85 is configured here, by way of example, to hold the printed circuit board 50 in a stationary manner (in the fully assembled state of the connector 14, 15). The holding element 85 (here, by way of example: all holding elements 85) comprises an elastically reversible material or is predominantly (more than 50%) or completely formed from an elastically reversible material. In the fully assembled state (see FIGS. 4A, 5), the printed circuit board 50 is mounted in the housing interior 40 by means of the at least one holding element 85. In the illustrated exemplary embodiments of FIG. 3, 4A, 5, a clamped mounting by means of the holding elements 85 is shown merely by way of example (and in the fully assembled state of the connector 14, 15). By mounting the printed circuit board 50 by means of the holding element 85 described above, mechanical action on the housing 20 is advantageously transmitted to the printed circuit board 50 only in a damped manner. This advantageously reduces the risk of premature functional impairment or damage to the printed circuit board 50.

The printed circuit board 50 is (in the fully assembled state of the connector 14, 15) mounted here, by way of example, by means of the holding element 50 in the housing interior 40 in such a way that the printed circuit board 50 is mechanically decoupled from the housing 20. As a result, mechanical influences acting on the housing 20 (e.g., shocks, vibrations, etc.) are not transmitted directly to the printed circuit board 50, but only in a damped manner.

In this embodiment, the printed circuit board 50 is mounted in the housing interior 40 by means of the at least one holding element 85 in such a way that the printed circuit board 50 has no direct mechanical contact with the inner wall 60 of the housing 20 or with elements that are formed in one piece with the inner wall 60 of the housing 20. This results in a further improved mechanical decoupling of the printed circuit board 50 from the housing 20 and reduces the risk of the printed circuit board 50 being damaged by shocks, vibrations, etc.

In this exemplary embodiment, the at least one holding element 85 (here: the two visible holding elements 85) are arranged in or on the inner wall 60, here in the first portion 61.

By way of example, the holding element 85 has a recess 86 here. This recess is designed here, by way of example, as a slot 87 or as a holding element groove. The printed circuit board 50 is arranged with a printed circuit board edge 58 in the recess 86. Here, by way of example, it is mounted in the recess 86 in a clamped manner (see also FIG. 4A).

It can be provided, as shown here by way of example, that the holding element 85 mounts the printed circuit board 50 laterally, in particular exclusively, on one printed circuit board side 56 and in particular does not extend through a through-opening of the printed circuit board 50.

It can be provided that the holding element 85 extends through the inner wall 60 from an external environment 41 of the connector 14, 15 into the housing interior 40, wherein the holding element 85 in this case, in particular, seals the housing interior 40 against the external environment 41 (see in particular FIG. 4A, 5, 6A, 6B in this respect).

However, it can also be provided that the holding element 85 is arranged directly in the housing interior 40, for example on or in the inner wall 60 of the housing 20. The holding element 85 can, for example, be designed as a separate part that is mounted on the inner wall 60. However, the holding element 85 can also be formed in one piece with the inner wall 60. For this purpose, it can be formed in one piece with the inner wall 60 in a two-component injection molding process, for example without contact with the external environment (see in particular FIG. 4A, 5, 6A, 6B in this respect).

The holding element 85 (here: the two visible holding elements 85) have an insertion funnel 88 on their side facing the printed circuit board 50. Said insertion funnel has a V-shape here, by way of example. This facilitates the correct coupling of the printed circuit board 50 to the holding element 85. The holding element 85 thus has a mouth-like shape.

The holding element 85 (here: the two visible holding elements 85) can protrude, for example, by at least 1 mm, preferably by at least 3 mm, from the inner wall 60 into the housing interior 40. Preferably, the holding element 85 protrudes in a range between 1 mm and 2.5 cm into the housing interior 40, starting from the inner wall 60 or from a point at which the holding element 85 is connected to a housing shell.

In FIG. 3, it can also be seen that (here) the first housing shell 21 has a guide structure for mounting the printed circuit board 50 in or on the first housing shell 21. The guide structure is designed here in the form of two opposing guide slots 70. In this case, the guide structure or the guide slots 70 protrude from the first portion 61 of the inner wall 60 in the direction of the second housing shell 22. They can, for example, have a slight oversize compared to a width of the printed circuit board 50, so that the printed circuit board 50 can be moved (e.g., pushed) to its destination easily but in a guided manner. Alternatively or additionally, it is also possible that the guide structure is formed on the second housing shell 22.

The guide structure, here in the form of the guide slots 70, can, for example, be designed to couple the printed circuit board 50 to the holding element 85 during assembly in the housing interior 60 by means of the guide structure, or to insert it into the holding element 85 (here: into the two neighboring and mutually spaced holding elements 85). The guide structure and the holding element 85 can, for example, be designed relative to one another in such a way that, in a (force-free) state of the connector in which the printed circuit board 50 is coupled to the holding element 85 (or to the holding elements 85) or is mounted by the holding element 85 (or by the holding elements 85), there is no (longer any) mechanical contact between the guide structure and the printed circuit board 50. This facilitates the assembly of the printed circuit board 50 (e.g., correct and securely positioned coupling of the printed circuit board 50 and the holding element 85) and, at the same time, it is mechanically decoupled from the housing 20 in the assembled state.

The holding element 85 can, for example, comprise or be formed, in particular to more than 50%, from a material selected from the group: rubber, natural rubber, silicone, thermoplastic elastomers (TPE), thermoplastic polyamide elastomers (TPE-A), thermoplastic copolyester elastomers (TPE-C), urethane-based thermoplastic elastomers (TPE-U) or materials with a similar physical effect. Alternatively or additionally, it can be provided that the holding element 85 has a Shore A hardness of at most 60, preferably of at most 50, particularly preferably of at most 45.

In FIG. 3, it can also be seen that the connector 14, 15 has, by way of example, at least one connection unit 23 arranged in the housing 20 on a connection side 27 of the housing 20, for connection to the vehicle 12 or the power supply device 16 or the load 19. Furthermore, a connection unit sealing element 25 is provided, which here, by way of example, surrounds the connection unit 23 circumferentially. The connection unit 23 preferably has plug connectors (e.g., at least one male contact element and/or at least one female contact element), which are designed for electrically contacting mating plug connectors. It is understood that the connection unit 23 can also be arranged transversely to a longitudinal direction L (axial direction) or longitudinal axis of the housing 20. It can, for example, be designed as a SCHUKO plug, three-phase plug or the like so that such a connector 15 can be designed for connection to a normal household socket or three-phase socket or the like. The connection side 27 can therefore also be understood to be a connection end of the housing 20. A line side 28 is provided at an end of the housing 20 that is opposite the connection side 27. On the line side 28, here, by way of example, a line element 17 of the housing 20 extends through the housing 20 from a housing interior 40 of the housing 20 into an external environment 41 or an external space of the housing 20. In this case, the external environment 41 or the external space is, for example, the space or the surroundings or the environment in which an operator can touch the connector 14, 15. The line element 17 can, for example, be the connecting line 13. Likewise, the line element 17 can, for example, be a cable stub, to which the connecting line 17 can be connected. Another possibility is that the line element 17 electrically contacts the coupling 3 or additional coupling 6. In principle, the coupling 3 or the additional coupling 6 can also represent the line element 17, which extends through the housing 20 from the housing interior 40 into the external space or the external environment 41 of the housing 20 or is in, for example direct, contact with the external space 41. Furthermore, a line element sealing element 26 is provided, which here, by way of example, circumferentially surrounds the line element 17.

The longitudinal direction L of the connector 14, 15 and thus of the housing 20 extends here from the connection side 27 to the line side 28. Since the connector 14, 15 has here, by way of example, a curved housing shape, the longitudinal direction L is therefore not straight but follows the curved housing shape, i.e., it is curved. For the connection unit 23 and the line element 17, the longitudinal direction L is in particular a central axis. A radial direction R is oriented perpendicularly to the longitudinal direction L. A circumferential direction U revolves around the longitudinal direction L.

Furthermore, the housing 20 has a sealing element 24, which is arranged between the first housing shell 21 and the second housing shell 22. The sealing element 24 is configured to seal the housing interior 40 against the external environment 41 of the housing 20, for example by means of a sealing portion 33. The sealing element 24 here, by way of example, rests at least in portions on both the first housing shell 21 and the second housing shell 22 (in the sealing portion 33). It is preferably provided that the sealing element 24 rests against the first housing shell 21 along more than 30% of its length, preferably more than 50% of its length and/or rests against the second housing shell 22 along more than 30% of its length, preferably more than 50% of its length.

In this exemplary embodiment, the sealing element 24 is formed in one piece. Here, by way of example, it is designed in a closed ring shape, although other shapes, such as a horseshoe shape, are also possible. The sealing element 24 has here, by way of example, a Shore A hardness of at most 80, preferably of at most 60, and more particularly preferably of at most 45. For example, a Shore A hardness of 30 or 35 or 40 or 45 can be provided.

In this embodiment, the first housing shell 21 has, by way of example, a receiving region or receiving portion 30, which is designed here, merely by way of example, in the form of a groove 31. This receiving portion 30 runs slightly below an end face (here: an outer wall) of the first housing shell 21 that faces the second housing shell 22. The receiving portion 30 is delimited here in such a way that the outer wall of the first housing shell 21 protrudes, for example by at most 2 mm, preferably by at most 1 mm beyond an inner wall delimiting the groove 31, e.g., by at most 2 mm, preferably by at most 1 mm. In the assembled state of the housing 20, the sealing element 24 is arranged on or in the receiving region 30, here: in the groove 31.

The printed circuit board 50 is here (in the fully assembled state of the housing 20, see, for example, FIG. 4), by way of example, arranged completely within the housing interior 20. The printed circuit board 50 has here, by way of example, an electrical and/or electronic circuit 51. It can, for example, be provided that the printed circuit board 50 has dimensions in which a length is at least 2 cm and, for example, in a range between 2 cm and 18 cm, preferably, for example, in a range between 4 cm and 15 cm and, for example, is 8 cm or 10 cm or 12 cm, and in which a width is at least 1.5 cm and, for example, in a range between 1.5 cm and 12 cm, preferably in a range between 2.5 cm and 8.5 cm and, for example, is 3 cm or 4 cm or 5 cm or 6 cm or 7 cm or 8 cm.

The printed circuit board 50 has at least one SMD component 52 (SMD=surface-mounted device), for example an integrated circuit, a sensor, a resistor, a capacitor and/or a coil or the like.

The SMD component 52 can also, for example, be a relay 53 or a voltage converter 54, wherein the voltage converter 54 generates, for example, a voltage in the range of 7 V to 25 V, preferably in the range of 13 V to 20 V, from a mains voltage (for example, in the range of 100 V to 130 V or in the range of 210 V to 260 V or in the range of 330 V to 410 V) applied to the connector 14, 15.

The relay 53 can, for example, have a mass in the range between 10 g and 70 g, preferably between 20 g and 45 g. It can be designed, merely by way of example, in an alternative embodiment as a THT component (not shown here).

The voltage converter can, for example, have a mass in the range between 10 g and 70 g, preferably between 15 g and 40 g. It can be designed, merely by way of example, in an alternative embodiment as a THT component (not shown here).

The printed circuit board 50 is equipped here, by way of example, on both sides. Here, by way of example, at least one SMD component 52 is provided on each of the two sides of the printed circuit board 50, wherein in particular at least one SMD component 52 is arranged on each side of the printed circuit board 50.

In the assembled state of the housing 20, as can be seen better in FIGS. 4A and 5, the printed circuit board 50 is mounted in a clamped manner along a clamping direction K between the first housing shell 21 and the second housing shell 22, the clamped mounting of the printed circuit board 50 being achieved by means of holding elements 85 which are opposite one another here. Advantageously, in this exemplary embodiment, a screw connection or a materially bonded connection of the printed circuit board 50 to one of the two or both housing shells 21, 22 can be dispensed with, wherein, at the same time, a stationary fastening of the printed circuit board 50 in the housing 20 is nonetheless achieved. At the same time, this advantageously provides a damping and/or mechanical decoupling of pressure effects, shocks or vibrations on the housing 20 (for example, from the external space or the external environment 41, for example due to a fall or vibrations in a vehicle or a vehicle driving over or rolling over the connector 14, 15, etc.) with respect to the printed circuit board 50 arranged in the housing interior 40. A decoupling of, for example, thermally induced compressive or tensile stresses or of mechanical loads, for example through lines from the housing interior 40 to the printed circuit board 50, is also advantageously brought about by the mounting of the printed circuit board 50 by means of the at least one holding element 85. This advantageously makes it possible to use SMD components 52, which remain failure-free, within the specifications with regard to mechanical loads on the connector 14, 15, over the service life of the connector 14, 15.

Furthermore advantageously, it is thus made possible that the (SMD) components on the printed circuit board 50 do not have to be potted in order to protect them from mechanical influences acting on the printed circuit board 50. As a result, the printed circuit board 50 can be produced cost-effectively and simply, and the circuit 51 can be constructed to be more compact and smaller than if it were (predominantly) equipped with THT components. This particularly advantageously also makes it possible to equip the printed circuit board 50 with one or more relays 54 and/or power supplies or voltage converters 54 in SMD design, which have a considerably higher weight than, for example, simple resistors, capacitors or coils.

FIG. 4A is a schematic cross-section through the housing 20 of a connector 14, 15.

FIG. 4B is a detail view of the connector 14, 15 of FIG. 4A before the printed circuit board 50 is mounted by the holding element 85.

FIG. 4C is a detail view of the connector 14, 15 of FIG. 4A, with the printed circuit board 85 mounted by the holding element 85.

FIGS. 4A, 4B and 4C are described together below.

FIG. 4A shows that the housing 20 has here, by way of example, a third housing shell 81, wherein the third housing shell 81 is arranged at least in portions on a first outer side 45 of the first housing shell 21. The housing 20 here, by way of example, also has a fourth housing shell 82, wherein the fourth housing shell 82 is arranged at least in portions on a second outer side 46 of the second housing shell 22.

The third housing shell 81 and fourth housing shell 82 can, for example, be made of a soft or softer material than the first housing shell 21 and second housing shell 22. For example, the third housing shell 81 and the fourth housing shell 82 can comprise as material (in particular to more than 50%): rubber, natural rubber, silicone, thermoplastic elastomers (TPE), thermoplastic polyamide elastomers (TPE-A), thermoplastic copolyester elastomers (TPE-C), urethane-based thermoplastic elastomers (TPE-U) or materials with a similar physical effect. Alternatively or additionally, the material may have a Shore A hardness of at most 60, preferably of at most 50, particularly preferably of at most 45. In this way, the connector 14, 15 can, for example, have a particularly good grip for an operator, and it can also already damp shocks on its outer side.

The connector 14, 15 has at least one holding element 85 in the first portion 61 of the inner wall 65 and also at least one holding element 85 in the second portion 62 of the inner wall 65. The printed circuit board 50 is held on two opposite printed circuit board sides 56 between the holding elements 85 of the first portion 61 and of the second portion 62 in the housing interior 40. Here: clamped, by way of example.

As is more clearly visible in FIG. 5, the connector 14, 15 can, for example, have two holding elements 85, spaced apart from one another along the longitudinal direction L, in the first portion 61 of the first housing shell 21 and a single holding element 85 in the second portion 62 of the second housing shell 22. In this case, all three holding elements 85 mount the printed circuit board 50 in a clamped manner. This results in a kind of three-point suspension of the printed circuit board 50 in the holding elements 85.

As shown here by way of example, the at least one holding element 85 of the third housing shell 81 can be formed in one piece with the third housing shell 81. It can protrude into the housing interior 40 (from the first outer side 45 of the first housing shell 21 and extending through the first housing shell 21), as shown here by way of example.

As shown here by way of example, the at least one holding element 85 of the fourth housing shell 82 can be formed in one piece with the fourth housing shell 82. It can protrude into the housing interior 40 (from the second outer side 46 of the second housing shell 22 and extending through the second housing shell 22), as shown here by way of example.

The holding elements 85 shown here by way of example thus extend through the inner wall 60 from the external environment 41 of the connector 14, 15 into the housing interior 40. In this case, the holding elements 85 can seal the housing interior 40, for example against the external environment 41.

If the third housing shell 81 and the fourth housing shell 82 comprise one of the materials described above or similar materials, in particular soft and/or elastically reversible materials, then in addition to the good grip for an operator and shock damping from the outer side of the housing 20, the printed circuit board 50 is also particularly well mechanically decoupled from the housing 20 and/or damped by means of the at least one holding element 85.

In FIG. 4A, the guide structure in the form of a guide slot 70 can also be seen. In addition, in the region of the two holding elements 85 shown (at the top and bottom in FIG. 4A), a stop 71 can be seen. This stop 71 can, for example, be designed to be continuous with the guide structure. Like the holding element 85, the stop 71 has an insertion funnel 88, as well as a recess 86, which here is designed in the manner of a holding element groove or a slot 87. The stop 71 is spaced apart from the printed circuit board 50 in the force-free state of the connector 14, 15. This is clearly visible in FIGS. 4A, 4B and 4C.

In other words, it can be provided that the first (and/or second) housing shell 21, 22 has a stop 71, which protrudes from the first (or second) portion 61, 62 of the inner wall 60 in the direction of the printed circuit board 50. The stop 71 can protrude from the inner wall 60 in the direction of the printed circuit board 50, for example by at least 0.5 mm, preferably by at least 1 mm, and more particularly preferably by at least 2 mm. The stop 71 is spaced apart from the printed circuit board 50 in the force-free state. This spacing can, for example, be at least 0.5 mm, preferably at least 1 mm, particularly preferably at least 2 mm.

Since FIG. 4B here shows a state before coupling of the printed circuit board 50 to the holding element 85, it shows particularly well that a bottom of the recess 86 of the holding element 85 has a first distance d1 from the inner wall 60. A further bottom of the stop recess of the stop 71 has a second distance d2 from the inner wall 60. The further bottom of the stop recess of the stop 71 is shown in dashed lines since it is arranged behind the holding element 85 in the image plane.

In this case, the first distance d1 before the coupling of the printed circuit board 50 to or with the holding element 85 is greater than the second distance d2, for example by at least 0.1 mm or by at least 15%. For example, the first distance d1 is in a range between 0.2 mm and 4 mm larger than the second distance d2 before mounting the printed circuit board 50, preferably in a range between 0.4 mm and 2 mm.

FIG. 4C (like FIG. 4A) shows the coupled state of the printed circuit board 50 with the holding element 85. In this case, the printed circuit board 50 is mounted in a clamped manner between the holding element 85 (shown in FIG. 4C) of the first housing shell 21 and a holding element 85 on the opposite housing shell 22 (see also FIG. 4A). It is clearly visible that the bottom of the recess 86 has been displaced along the clamping direction K in the direction of the inner wall 60 and has come somewhat closer to the further bottom of the stop recess of the stop 71. Due to the elastically reversible material of the holding element 85, said holding element has been slightly compressed. As a result, it mounts the printed circuit board 50 (together with the holding element 85 arranged on the opposite housing shell 22, see FIG. 4A, which holding element is also slightly compressed.). The first distance d1 is also larger than the second distance d2 after the printed circuit board 50 is coupled to or with the holding element 85 (see FIGS. 4A and 4C), for example by at least 0.05 mm or by at least 15% or by at least 10%. For example, the first distance d1 is in a range between 0.1 mm and 3 mm, preferably in a range of 0.2 mm and 1 mm, larger than the second distance d2 after mounting the printed circuit board 50. A stationary mounting of the printed circuit board 50 along the radial direction R and along the longitudinal direction L can, for example, be effected by the frictional forces between the printed circuit board side 56 and the recess 86, in particular its bottom, and/or by frictional forces between the printed circuit board edge 58 and the walls of the recess 86. The stationary mounting of the printed circuit board 50 with respect to the radial direction R can be further improved by the walls of the recess 86 since, by way of example, they enclose the printed circuit board edge 58 on both sides in this embodiment.

In this way, in the force-free state or when only small forces act on the housing 20, the printed circuit board 50 is mechanically decoupled from the housing 20.

However, if greater forces are applied (e.g., when a vehicle rolls over the connector 14, 15), the holding element 85 can be compressed so much that the printed circuit board 50 comes into contact with the stop 71. This has the advantageous effect that the holding element 85 is not plastically deformed and can thus permanently cause a mechanical decoupling of the printed circuit board 50 from the housing 20 or can damp mechanical influences. At the same time or in addition, the stop 71 can prevent the printed circuit board 50 from exerting such a strong force on the holding element 85 that said holding element is pressed outward through the first or second housing shell 21, 22 and that the third or fourth housing shell 81, 82 possibly detaches from the first or second housing shell 21, 22 as a result. A separate rear grip of the holding element 85 with respect to the through-opening in the first or second housing shell 21, 22 can thus be omitted, which simplifies the production of the holding element 85 and/or of the third or fourth housing shell 81, 82.

Furthermore, in FIG. 4A, it can be seen that, in the first portion 61, the housing 20 has a first support element 75, which faces the second portion 62. The housing 20 also has a second support element 76, which faces the first portion 61. The first support element 75 extends here substantially (+/−30°) in parallel with a printed circuit board plane E. It protrudes here, by way of example, from the first housing shell 21 or from the first portion 61. The second support element 76 extends here substantially (+/−30°) in parallel with the printed circuit board plane E. It protrudes here, by way of example, from the second housing shell 22 or from the second portion 62.

Here, in the force-free state of the housing 20, the first support element 75 is spaced apart from the second support element 76 by a third distance d3. In this case, the spacing or the third distance d3 is preferably in a range between 0.05 mm and 4 mm, preferably in a range between 0.1 mm and 2 mm.

The two support elements 75, 76 are intended, on the one hand, to make simple assembly of the housing shells 21, 22 with one another possible so that a tight and gap-free housing 20 is created. At the same time, the support elements 75, 76 should come into contact with one another (“go solid”) as soon as a greater force from the external environment 41 acts on the housing 20 approximately along the printed circuit board plane E or along the direction of the support elements 75, 76. By mechanically contacting the support elements 75, 76 with one another, the housing 20, which is hollow here by way of example, is prevented from collapsing, and the printed circuit board 50 is prevented from having to absorb such forces.

It is understood that the first support element 75 can also come into contact with the second portion 22 or can be (slightly) spaced apart from the second portion 62 in the force-free state, if, for example, no second support element 76 is present. In the same way, the second support element 76 can be (slightly) spaced apart from the first portion 61 in the force-free state and can come into contact with the first portion 61 when a force is applied to the housing 20, if, for example, no first support element 75 is provided.

The spacing or the third distance d3 between the first support element 75 and the second support element 76 (or the second portion 62/the first portion 61) can, for example, be designed in such a way that, when a force of more than 1000 N, preferably more than 500 N, particularly preferably more than 200 N, and more particularly preferably more than 100 N, acts on the housing 20 substantially (+/−30°) along the printed circuit board plane E, the first support element 75 comes into mechanical contact with the second portion 62 and/or the second support element 76.

Similar considerations (force of more than 1000 N, preferably more than 500 N, particularly preferably more than 200 N, and more particularly preferably more than 100 N acting on the housing 20 substantially (+/−30°) along the printed circuit board plane E) also apply to a possible spacing between the second support element 76 and the first portion 61 so that the second support element 76 comes into mechanical contact with the first portion 61 and thus protects the housing 20 from collapsing and the printed circuit board 50 from damage.

The first and/or second support element 75, 76 also advantageously prevent a plastic deformation of the holding element 85 or a pushing through of the holding element 85 or the holding elements 85 from the housing interior 40 into the external environment 41.

FIG. 5 is a schematic perspective and partially opened plan view of the connector of FIG. 4A.

It can be clearly seen that, in the first portion 61 of the inner wall 60, two holding elements 85 are arranged, which are spaced apart from one another along the longitudinal direction L (here: by more than one width of the holding elements 85) and, in the second portion 62 of the inner wall, a single holding element 85 is arranged, which is located between the two holding elements 85 of the first portion 61 when viewed along the longitudinal direction L. In this way, the printed circuit board 50 is held by the three holding elements 85 in the manner of a three-point mounting. Here, it is mounted in a clamped manner along a clamping direction K between the holding elements 85.

The guide slots 70 are also clearly visible. In the force-free state of the connector 14, 15 shown here, they are spaced apart from the printed circuit board 50 in the same way as the stops 71 of the first and second housing shells 21, 22.

In this way, the printed circuit board 50 is optimally mechanically decoupled from the housing 20 by means of the holding elements 85. Due to the lateral mounting of the printed circuit board 50, a particularly large surface of the printed circuit board 50 is available for equipping with components, and the routing of the conductor tracks is also not hindered by openings for the mounting of the printed circuit board 50 by means of screws or clips, etc.

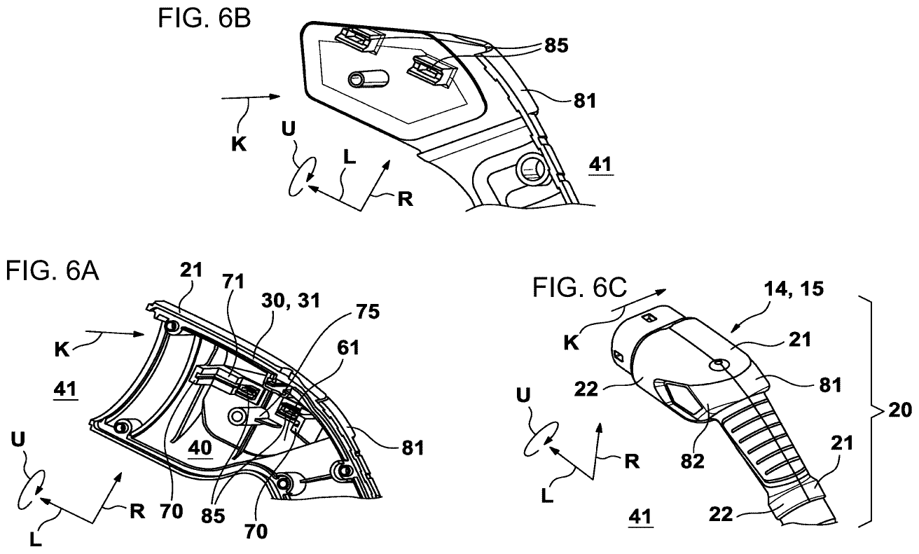

FIG. 6A is a schematic perspective view of a first housing shell 21 and the third housing shell 81 of the connector 14, 15 of FIGS. 4A and 5. The guide structure in the form of the two guide slots 70 as well as the stop 71 and the first support element 75 can be seen particularly well here. For coupling with the holding elements 85, the printed circuit board 50 can simply be inserted into the guide slots 70 and then pushed in the direction (here: clamping direction K) of the holding elements 85. This makes simple and securely positioned assembly possible, but also safe and damage-free disassembly of the printed circuit board 50.

FIG. 6B is a schematic perspective view of the third housing shell 81 of FIG. 6A. It is clearly visible how the two holding elements 85 are formed in one piece with the third housing shell 81. The holding elements 85 protrude counter to the clamping direction K from the wall of the third housing shell 81 in the direction of the housing interior 40 (see FIG. 6A). For example, they can protrude between 2 mm and 25 mm from the wall of the third housing shell 82 (calculated, for example, from the base point to the holding surface or the bottom in the insertion funnel 88).

FIG. 6C is a schematic perspective external view of the housing 20 of a connector 14, 15 with first, second, third and fourth housing shells 21, 22, 81, 82. It can be clearly seen that the third housing shell 81 and the fourth housing shell 82 are arranged in the gripping region of the connector 14, 15. The use of a soft and non-slip material for the third and fourth housing shells 81, 82 can improve user-friendliness (for example, in wet conditions) and also provides external shock damping if the connector 14, 15 falls on the floor, for example.

The two housing halves (first and third housing shells 21, 81 on the one hand, and second and fourth housing shells 22, 82 on the other hand) can be connected to one another to form the housing 20, for example by means of a screw connection. A housing 20 that is particularly simple to assemble and, for repair or maintenance purposes, to disassemble is provided in this way. This advantageously increases the sustainability of the connector 14, 15.

The supply line 10 shown in FIG. 1 may have one or two of the connectors 14, 15 described above.

1-13. (canceled)

14. A connector for a supply cable for electrically connecting a vehicle to a power supply device, which provides electric power, and/or to a load, which requires electric power, the connector comprising:
a housing with a housing interior;
a printed circuit board which has an electrical and/or electronic circuit; and
a holding element for the printed circuit board;
wherein the housing has an inner wall, which delimits the housing interior;
wherein the inner wall has a first portion and a second portion opposite the first portion; and
wherein the holding element has an elastically reversible material or is predominantly or completely made of an elastically reversible material,
wherein the printed circuit board is mounted in the housing interior in a clamped manner, using the holding element.

15. The connector according to claim 14, wherein:
the printed circuit board is mounted in the housing interior using the holding element in such a way that the printed circuit board is mechanically decoupled from the housing; and/or
the printed circuit board is mounted in the housing interior using the holding element in such a way that the printed circuit board has no direct mechanical contact with the inner wall of the housing or with elements which are formed in one piece with the inner wall of the housing.

16. The connector according to claim 14, wherein the holding element mounts the printed circuit board exclusively laterally on one printed circuit board side and does not extend through a through-opening of the printed circuit board.

17. The connector according to claim 14, wherein:
the holding element has a recess including a slot or a holding element groove;
the printed circuit board is arranged with a printed circuit board edge in the recess and is mounted in a clamped manner in the recess.

18. The connector according to claim 14, wherein:
the holding element is arranged in or on the inner wall; and/or
the holding element extends through the inner wall from an external environment of the connector into the housing interior, wherein the holding element seals the housing interior against an external environment.

19. The connector according to claim 14, wherein:
the connector has at least one holding element in the first portion of the inner wall;
the connector has at least one holding element in the second portion of the inner wall;
the printed circuit board is clamped in the housing interior on two opposite printed circuit board sides between the holding elements of the first portion and of the second portion.

20. The connector according to claim 14, wherein:
the housing has a first housing shell and a second housing shell, which is separate from the first housing shell;
the housing interior is enclosed by the first housing shell and the second housing shell;
the first housing shell has the first portion of the inner wall;
the second housing shell has the second portion of the inner wall.

21. The connector according to claim 20, wherein:
the housing has a third housing shell, the third housing shell is arranged at least in portions on a first outer side of the first housing shell, the holding element is formed in one piece with the third housing shell and protrudes into the housing interior; and/or
wherein the housing has a fourth housing shell, the fourth housing shell is arranged at least in portions on a second outer side of the second housing shell, and the holding element is formed in one piece with the fourth housing shell and protrudes into the housing interior.

22. The connector according to claim 14, wherein:
the housing has a first support element in the first portion, the first support element facing the second portion, the first support element extends in substantially in parallel with a printed circuit board plane, the first support element is spaced apart from the second portion and/or from a second support element of the second portion in a force-free state of the housing, and the spacing is in a range between 0.05 mm and 4 mm; and/or
wherein the housing has a second support element which faces the first portion, the second support element extends substantially in parallel with a printed circuit board plane, the second support element is spaced apart from the first portion or from a first support element of the first portion in the force-free state of the housing, and the spacing is in a range between 0.05 mm and 4 mm.

23. The connector according to claim 22, wherein:
the spacing between the first support element and the second portion and/or the second support element is configured in such a way that when a force of more than 1000 N acts on the housing along the printed circuit board plane, the first support element comes into mechanical contact with the second portion and/or the second support element; and/or
the spacing between the second support element and the first portion and/or the first support element is configured in such a way that when a force of more than 1000 N acts on the housing along the printed circuit board plane, the second support element comes into mechanical contact with the first portion and/or the first support element.

24. The connector according to claim 14, wherein:
the holding element includes or is formed from more than 50%, from a material selected from the group: rubber, natural rubber, silicone, thermoplastic elastomers (TPE), thermoplastic polyamide elastomers (TPE-A), thermoplastic copolyester elastomers (TPE-C), urethane-based thermoplastic elastomers (TPE-U), and/or
the holding element has a Shore A hardness of at most 60.

25. The connector according to claim 14, wherein the connector is configured to be electrically connected to a household socket or a mating connector of a vehicle or to a mating connector of a power supply device.

26. A supply cable for electrically connecting a vehicle to a power supply device which provides electric power, and/or to a load which requires electric power, the supply cable comprising:
a connector including:
a housing with a housing interior,
a printed circuit board which has an electrical and/or electronic circuit, and
a holding element for the printed circuit board,
wherein the housing has an inner wall, which delimits the housing interior,
wherein the inner wall has a first portion and a second portion opposite the first portion, and
wherein the holding element has an elastically reversible material or is predominantly or completely made of an elastically reversible material,
wherein the printed circuit board is mounted in the housing interior in a clamped manner, using the holding element; and
a connecting line which is electrically connected to the connector.
